(19) United States
(12) Patent Application Publication
(10) Pub. No.: US 2004/0203497 A1
(43) Pub. Date: Oct. 14, 2004

(54) Auto folder type mobile phone

(75) Inventors: Tae Hyeong Lim, Suwon-Shi (KR); Sung Soo Lee, Suwon-Shi (KR); Young Ok Chung, Suwon-Shi (KR)

Correspondence Address: DARBY & DARBY P.C., P. O. BOX 5257, NEW YORK, NY, 10150-5257, US

(73) Assignee: Samsung Electro-Mechanics Co., Ltd., Suwon-Shi (KR)

(21) Appl. No.: 10/401,406

(22) Filed: Mar. 27, 2003

(30) Foreign Application Priority Data
Jul. 2, 2002 (KR) 2002-37919
Nov. 27, 2002 (KR) 2002-74468

(51) Int. Cl. H04B 1/38; H04M 1/00

(52) U.S. Cl. 455/90.1; 455/550.1

(57) ABSTRACT

Disclosed is an auto folder type mobile phone. More specifically, an auto folder type mobile phone for automatically opening/closing the folder by means of the driving means, the auto folder type mobile phone capable of preventing noise generation by eliminating the portion where direction of applied force is reversed instantly, upon opening/closing of the folder, is provided.

### BACKGROUND OF THE INVENTION

1. Field of the Invention

The present invention relates generally to an auto folder type mobile phone for opening/closing a folder automatically, and more particularly to an auto folder type mobile phone for opening/closing the folder at a stable position by controlling a position of the folder and correcting a phase difference resulting from load and unstableness of the driving apparatus.

2. Description of the Related Art

Generally, a mobile phone or a cellular phone is a terminal for a mobile communication service that can be used in a uniform circle within a service area by making a part of customer's lines wireless. While an existing service is used at a limited area using line numbers, the mobile phone can be used regardless of a place using a logical personal number.

This mobile phone is easily portable and convenient for use, and so its demand increases tremendously, and is miniaturized and has multi-functions in order to fulfill customer's various desires.

Normally, the mobile phone is classified into a bar type where number (function) buttons are exposed outside, a flip type having a cover for shielding the buttons, and a folder type where the body is folded in halves, the folder type mobile phone being popular following the trend of miniaturization.

Generally, in the folder type mobile phone, the folder is hinged to allow the folder to rotate toward/from the body, and its opening/closing is made by a rotation of the folder in a direction or a reverse direction round a center of the hinge.

However, the related folder type mobile phone is disadvantageous in that when a user wants to open/close the folder, he should operate the folder by one hand with the other hand holding the body because of a heavy weight of the folder.

Suggested is a mobile phone for more easily opening/closing the folder while solving the problem, and its typical embodiment is an auto folder type mobile phone using a driving apparatus.

FIG. 1 is a perspective view of showing an appearance of a general auto folder type mobile phone.

As shown in the figure, the auto folder type mobile phone comprises a body 10 and a folder 20. The body has a button 11 for inputting normal various functions and numbers, and a mic 12. Although not shown in this figure, various components and circuits are included for a telephone communication, and a battery pack 13 for power supply is included detachably.

Additionally, the folder 20 includes a display window 21, which shows information about the telephone communication and function, a speaker 22, various components and circuits.

In this mobile telephone constructed as above, the folder 20 is opened/closed automatically from the body 10 by an operation signal of a switch sw, which is positioned at a side of the body 10.

FIG. 2 is an exploded perspective view of showing main parts of the related auto folder type mobile phone, and FIG. 3 to FIG. 5 are cross sectional views of sequentially showing operations of a hinge shaft and a hinge cam in the related auto folder type mobile phone. FIG. 6 is a view of showing directions of forces at a mutual operation surface of the hinge shaft and the hinge cam in the related auto folder type mobile phone.

As shown in the figures, the body 10 is provided with fixing units 100 projected, which have holes faced each other at a specific interval. Between the fixing units is inserted a pipe shaped housing 200 which is projected from the folder 20.

In the fixing unit 100 and the housing 200 are positioned a driving means and a dynamic transfer means for an automatic opening/closing by the switch sw signal.

The driving means comprises a motor 300 that is operated by the switch sw signal, and a speed reducer 310 connected to an output end of the motor to decrease a rotation rate and to increase a torque by preventing, a reversing movement. The dynamic transfer means comprises a hinge shaft 400 connected to an output end of the speed reducer 310 to work integrally with the speed reducer, a hinge cam 410 engaged with the hinge shaft 400 and positioned in the fixing unit 100, and a elastic body 450 applying a elastic force to the hinge cam 410 and the fixing unit 100.

A numeral 210 is a bracket for fixing the housing 200 to the folder.

The above related auto folder type mobile phone is disadvantageous in that the opening/closing operation of the folder 20 generated noise because of a mechanism between the hinge cam 410 and the hinge shaft 400 that is mounted in the housing 200 when the housing 200 is engaged with the fixing unit 100. This phenomenon is more serious specially when the folder 20 is opened/closed manually.

This phenomenon is because of Backlash of the speed reducer 310 for increasing the torque. That is, this is shown because a direction of force applied to an operation surface is instantly reversed when a projected part of the hinge shaft 400 rotates across a concaved part of the hinge cam 410, due to the backlash.

As shown in the drawings, a projection 411 on edges of the hinge cam 410 is provided with forces in the left and right direction, and these forces are shown in a horizontal direction.

In more detail with respect to FIG. 6, when the hinge cam 410 is positioned at an “a” position, forces F1 and F2 acts in directions as shown, and when the hinge cam 410 rotates in a clockwise to a “b” position, the operation surface is in a reverse direction, thus making the forces to be F3 and F4, respectively. The force F1, F2 and the forces F3, F4 respectively have a same magnitude and have opposite directions to each other. However, in case the force's directions are reversed as mentioned above, noise is generated due to the foregoing backlash. Although this noise is not a serious defect that affects a commodity vale of the auto folder type mobile phone, it causes an uncomfortable feeling to users, thus decreasing reliance of the phone.

### SUMMARY OF THE INVENTION

Accordingly, the present invention has been made keeping in mind the above problems occurring in the prior art, and an object of the present invention is to provide an auto folder type mobile phone for eliminating a part where the direction of the force of the operation surface is reversed instantly when the projected part of the hinge shaft passes an concave part of the hinge cam, thus eliminating noise.

That is, this object is to disperse the force in order to prevent the forces from acting in the rotation direction and so decreases change of the forces in the rotation direction to decrease noise resulting from a connection.

In order to accomplish the above object, the present invention provides an auto folder type mobile phone including: a pair of fixing units, each of which is positioned at one end of a body, with holes facing each other; a cylinder shaped housing, connected with a folder, positioned between the pair of the fixing units, and its both sides are opened; a driving means, mounted in an interior of the housing, for selectively generating a rotation force; a hinge shaft, whose one end is connected with the driving means, for being rotated integrally with the driving means, and whose other end has a projected connection part; and a hinge cam provided to an interior of the fixing units, whose one end receives a supporting force of the elastic body, for being connected with the connection part, wherein the one end has a concaved central part and a mountain shape of curved edges in both sides, so that force applied to the operation surface of the hinge shaft, is dispersed in an axial direction and a radial direction.

It is an preferable aspect of the present invention that the connection part of the hinge shaft is a triangular prism shape of a pentahedron, and its edge forms a curved surface.

It is another preferable aspect of the present invention that the connection part of the hinge shaft and a portion connected with the hinge cam are formed for being engaged with each other by corresponding size.

It is another preferable aspect of the present invention that the driving means comprises a motor connected to a switch, for generating rotational force in forward and reverse directions, and a speed reducer connected to an output end of the motor, for preventing reversing movement, reducing rotation rate.

It is another preferable aspect of the present invention that the driving means receives an operation signal from a switch provided to one side of the body, for generating rotational force in forward and reverse directions.

It is another preferable aspect of the present invention that the elastic body is provided to an interior of the fixing units, one end of which is fixed in one side of the interior of the fixing units, the other end of which applies elastic force toward the hinge shaft, and the elastic body is a coil spring transformed elastically so that the hinge cam is possibly rotated by external force applied to the folder.

It is another preferable aspect of the present invention that the motor is fixed in an interior of the housing, for operating integrally.

It is another preferable aspect of the present invention that the speed reducer is connected with one end of the hinge shaft, for delivering decreased rotational force.

According to another embodiment of the present invention provides an auto folder type mobile phone including: a pair of fixing units, each of which is positioned at one end of a body, with holes facing each other; a cylinder shaped housing, connected with a folder, positioned between the pair of the fixing units, and its both sides are opened; a driving means, mounted in an interior of the housing, for selectively generating a rotation force; a hinge shaft provided to an interior in one side of the fixing unit, for being moved elastically to a side of the housing, influenced by supporting force from the elastic body, and whose end portion extended to a housing side, has a connection part of a projected shape; a hinge cam, one end of which is connected with the driving means, for being rotated integrally, the other end of which is elastically connected with the hinge shaft, wherein the other end has a concaved central part and a mountain shape of curved edges at both sides so that force applied to the operation surface of the hinge shaft can be dispersed in a radial direction and an axial direction.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of showing an appearance of a general auto folder type mobile phone;

FIG. 2 is an exploded perspective view of showing main parts of the related auto folder type mobile phone;

FIG. 3 to FIG. 5 are cross-sectional views of sequentially showing operations of a hinge shaft and a hinge cam in the related auto folder type mobile phone;

FIG. 6 is a view of showing directions of forces at a mutual operation surface of the hinge shaft and the hinge cam in the related auto folder type mobile phone;

FIG. 7 is an exploded perspective view of showing main parts of the related auto folder type mobile phone;

FIG. 8 to FIG. 10 are cross-sectional views of sequentially showing operations of a hinge shaft and a hinge cam in the related auto folder type mobile phone;

FIG. 11 is a view of showing the hinge cam in an “A” direction of FIG. 7;

FIG. 12 is an illustrative view of showing the directions of the forces on the operation surface of the hinge shaft and the hinge cam in the auto folder type mobile phone of the present invention;

FIGS. 13 through 15 are cross-sectional views of sequentially showing mutual operations of a hinge cam and a hinge shaft according to another embodiment of the auto folder type mobile phone of the present invention; and

FIG. 16 is a drawing schematically showing directions of force on an operation surface of a hinge cam and a hinge shaft according to another embodiment of the auto folder type mobile phone of the present invention.

### DESCRIPTION OF THE PREFERRED EMBODIMENTS

A preferable embodiment of the auto folder type mobile phone of the present invention is explained in detail with respect to the drawings, in which the same reference numerals are used throughout the different drawings to designate the same or similar components.

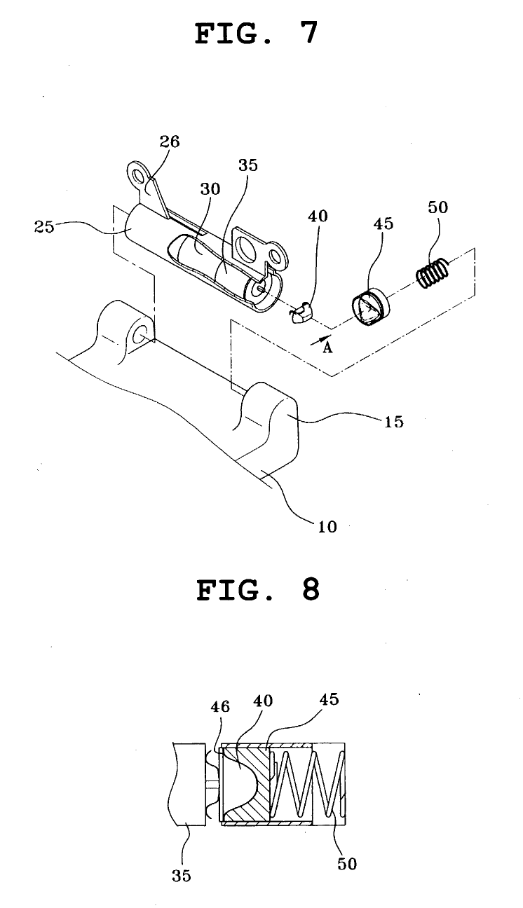

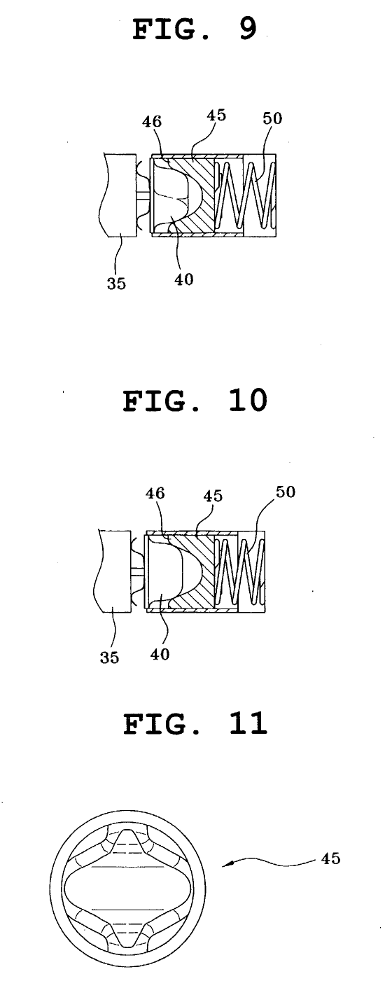

FIG. 7 is an exploded perspective view of showing main parts of the related auto folder type mobile phone. FIG. 8 to FIG. 10 are cross-sectional views of sequentially showing operations of a hinge shaft and a hinge cam in the related auto folder type mobile phone.

FIG. 11 is a view of showing the hinge cam in an “A” direction of FIG. 7, and FIG. 12 is an illustrative view of showing the directions of the forces on the operation surface of the hinge shaft and the hinge cam in the auto folder type mobile phone of the present invention.

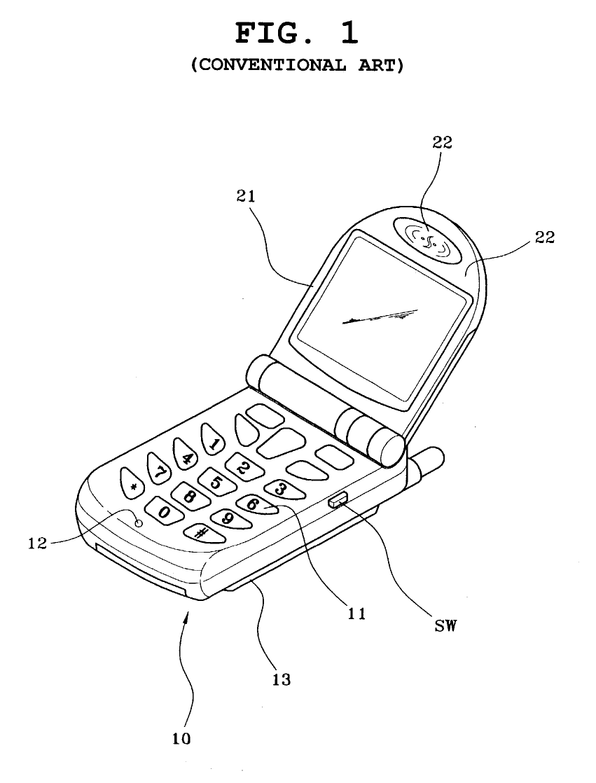

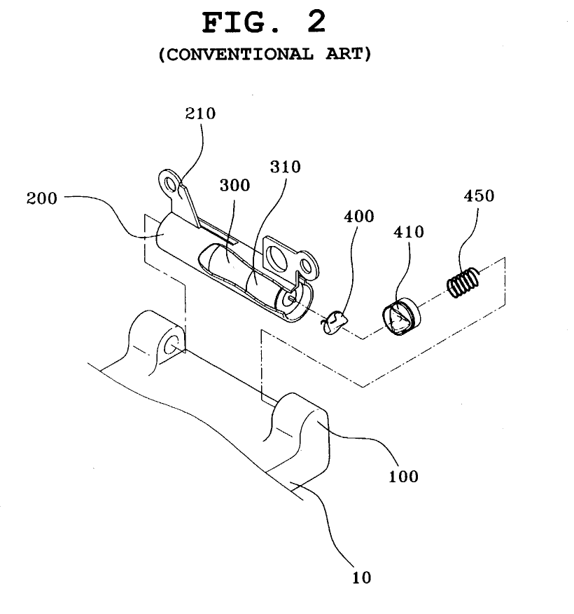

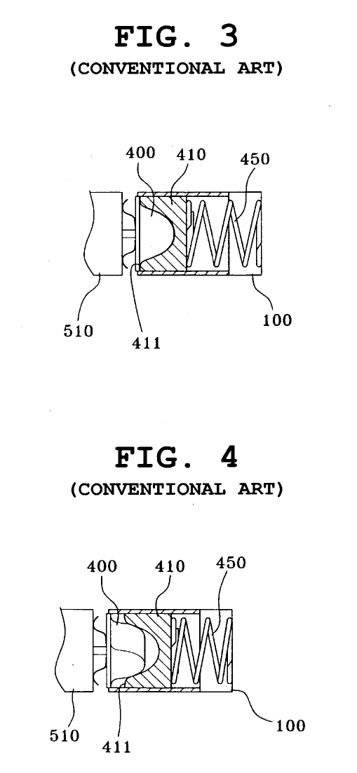

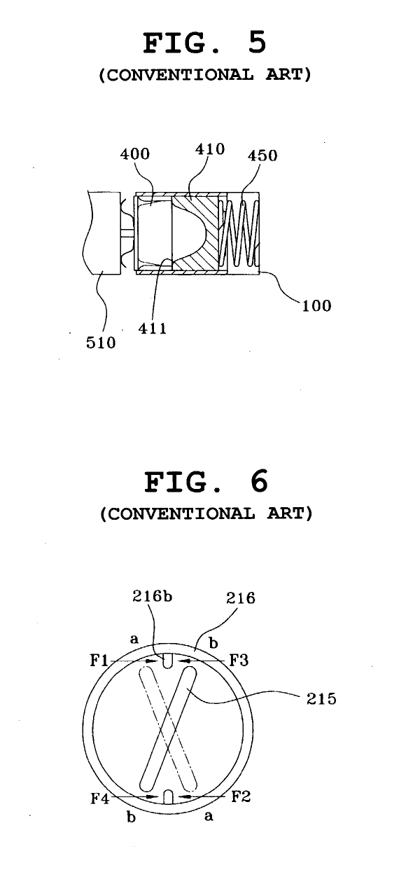

The auto folder type mobile phone according to a preferable embodiment of the present invention has an appearance similar to the general related auto folder type mobile phone of FIG. 1, and a similar cross section to the FIG. 3 to FIG. 5. However, in this present invention, the shape of the hinge shaft and the hinge cam, which are the driving apparatuses for opening/closing the folder automatically, and the force direction applied to the operation surface in case of the rotation are different from the related art.

That is, a structure for driving the folder 20 according to the present invention is well shown in the cross sectional views of the fixing unit 15 and the housing 25 of FIG. 7.

The driving apparatus of the folder 20 of the mobile phone of the present invention comprises a driving means fixed in the housing 20 to generate a driving force and a dynamic transfer means including a elastic member for acting a elastic force and a pair of members selectively connected to the driving means. The driving means is formed integrally at a side of the folder 20 or is positioned in the cylinder shaped housing 25 that is fixed by the bracket, and the driving means generates a driving force for rotating the folder 20, and comprises normal forward reverse motor 30 and a speed reducer 35.

The motor 30 is operated by a signal of the switch sw positioned at a side of the body, and is supplied with a power from a battery pack 13 mounted on the mobile phone, according to the switch sw signal and generates a specific rotation force in a forward/reverse direction.

Additionally, an output end of the motor 30 is provided with a speed reducer 35, and the speed reducer 35 is a combination of normal gears to decrease the rotation force of the motor 30 at a uniform rate and increase a torque while preventing a reversing movement.

In the driving means constructed as above, the rotation force generated by the motor 30 is decreased by the speed reducer 35 to rotate the output end.

Meanwhile, normal small motor 30 and speed reducer 35 can be used for the driving means as in the present invention, and various driving devices can be also used as long as they generate stable rotation forces in a forward/reverse direction in order to drive the folder 20 and simultaneously prevent the reversing movement.

The dynamic transfer means comprises a hinge shaft 40 and a hinge cam 45, and as shown in the drawing, the hinge shaft 40 is connected to the output end of the speed reducer 35, is rotated integrally with the speed reducer. The hinge shaft 40 is positioned in the housing 25, and has tapers at its both sides to make its central part projected, and the hinge cam 45 is positioned in the fixing unit 15, and has a taper formed inside in order to make its central part concaved in an opposite direction to the projected part of the hinge shaft 40.

The hinge shaft 40 and the hinge cam 45 constructed as above is applied with the elastic force of the elastic body to form a fixing part by engaging with each other in case the driving force of the driving means is transferred. The shaft and the cam are detached in case an external force is applied to the folder 20 during an automotive mode operation or during a manual opening/closing of the folder 20.

That is, a coil shaped elastic body 50 is positioned in a fixing unit 15 of the pair of the fixing units 15 that is integrally formed at a side of the body 10. One end of the elastic body 50 is fixed to an internal side of the fixing unit 15, and the other end is contacted with a surface of the hinge cam 45 to perform the elastic force. This elastic body 50 keeps a larger elastic force than the driving force generated by the driving means, and applies the elastic force to the hinge shaft 40 and the hinge cam 45 to make them selectively engaged or detached.

In more detail, the elastic body 50 applies a larger force to the hinge shaft 40 and the hinge cam 45 than the driving means in case the folder 20 is opened or closed on the basis of the body 10 by the driving means, and so the elastic keeps the engagement state of the hinge shaft 40 and the hinge cam 45 and causes a elastic transformation to allow the hinge shaft 40 and the hinge cam detached in case of opening/closing the folder 20 manually.

Meanwhile, the hinge shaft 40 and the hinge cam 45 among the components of the dynamic transfer means is a substantial characteristic of the present invention, and a detail of the characteristic is as follows.

As shown in FIG. 7, a part of the hinge shaft 40 contacted with the hinge cam 45 is approximately a triangular prism shape of a pentahedron, and its edge part forms a smooth surface. Additionally, a surface of the hinge cam 45 contacted with the hinge shaft 40 has, on its edge, a projection that has more gently curved edges in comparison with the related construction. That is, the hinge cam 45 has a concaved central part and mountain shaped edges at both sides, and so force applied to the operation surface with the hinge shaft 40 can be dispersed in a radial direction and in an axial direction of the housing 25 when the cam rotates engaged with the hinge shaft 40.

The operation of the auto folder type mobile phone of the present invention constructed as above is as follows.

First, when a user rotates the folder 20 in a forward direction or a reverse direction to/from the body 10 in order to manually close/open the folder, the housing 25 rotates in the forward/reverse direction according to the rotation of the folder 20.

The rotation force applied to the housing 25 is larger than the elastic force generated by the elastic body 50, and so the hinge shaft 40 and the hinge cam 45 are slipped and separated from each other. That is, the hinge shaft 40 is rotated integrally with the housing 25, and so the hinge cam 45 goes back and compresses the elastic 50, thus opening/closing the folder.

Additionally, in case the switch sw is operated that is positioned at a side of the body 10 in order to manually open the folder 20, the motor and the speed reducer 35 generates a driving force by the signal of the switch.

Subsequently, the hinge shaft 40 that is connected to the output end of the speed reducer 35 rotates, and the hinge cam 45 that is connected to the hinge shaft 40 rotates by a uniform angle to compress the elastic body 50, thus making the elastic body move horizontally by a restoration force of the elastic body 50 at the operation of the driving means.

That is, the hinge shaft 40 in the housing 25 is applied with the rotation force of the driving means in the engagement state with the hinge cam 45, and the elastic force of the elastic body 50 is larger than the driving force of the driving means, and so the hinge shaft 40 and the hinge cam 45 maintains the mutual engagement, thus rotating the driving means.

In this case, the hinge shaft 40 in the housing 25 rotates in the hinge cam 45 without going over a top when the shaft crosses the hinge cam 45, and so a direction of the force is dispersed not in a rotation direction of the hinge shaft 40, but in an axial direction and a radial direction of the housing 25, thus decreasing noise.

That is, the rotation movement is transferred and however an external force due to the elastic force in the axial direction is blocked, and so a load transferred to the axis can be reduced to prevent the elastic force of the elastic force 50 from being transferred to the speed reducer 35.

Accordingly, the “backlash” phenomenon can be prevented, thus increasing reliance and performance of the phone, and decreasing noise.

Meanwhile, also in case the folder 20 is closed and a load is applied to the folder 20, the folder 20 is opened/closed in a same way as the foregoing, thus decreasing noise.

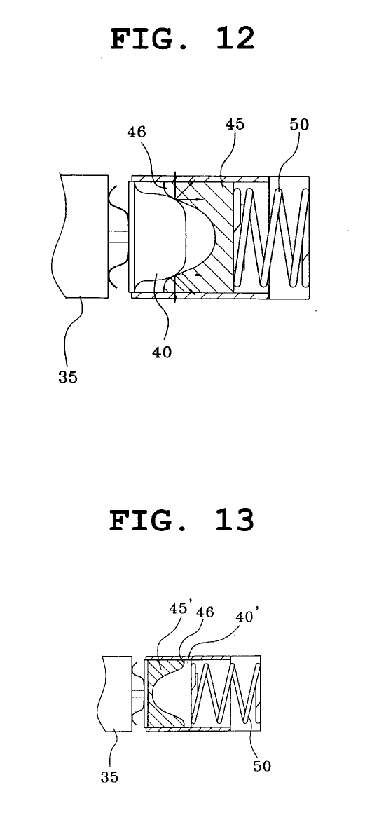

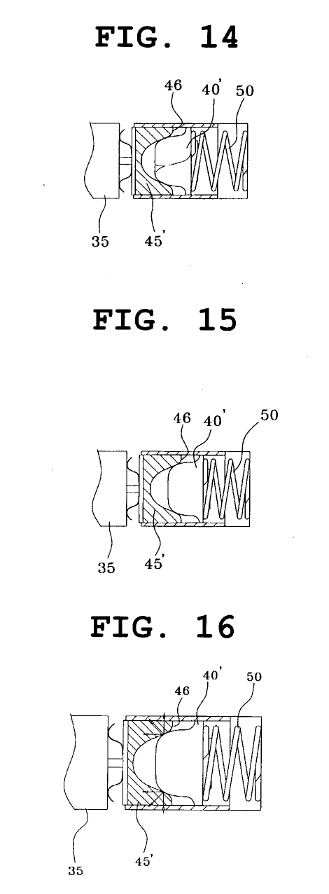

FIGS. 13 through 15 are cross-sectional views of sequentially showing mutual operations of a hinge cam and a hinge shaft according to another embodiment of the auto folder type mobile phone of the present invention, and FIG. 16 is a drawing schematically showing directions of force on an operation surface of a hinge cam and a hinge shaft according to another embodiment of the auto folder type mobile phone of the present invention. In the following, description will be made with reference to FIG. 7 and the same reference numerals is used for the same parts except the hinge cam and the hinge shaft.

As shown in FIG. 7, the auto folder type mobile phone of the present embodiment, has the same construction as the mobile phone of the embodiment previously described except the dynamic transfer means in which the hinge cam 45′ and the hinge shaft 40′ are changed in their positions.

Namely, according to another embodiment of the auto folder type mobile phone of the present invention, the hinge cam 45′ is connected with the driving means installed in the side of the housing, and the hinge shaft 40′ is connected, within one fixing unit corresponding to the housing, with the hinge cam 45′, influenced by supporting force from the elastic body.

Here, the driving means is formed integrally at a side of the folder 20 or is positioned in the cylinder shaped housing 25 that is fixed by the bracket, and the driving means generates a driving force for rotating the folder 20, and comprises normal forward reverse motor 30 and a speed reducer 35.

The motor 30 is operated by a signal from the switch sw positioned at a side of the body, and generates specific rotation force in a forward/reverse direction, provided with power from a battery pack 13 mounted on the mobile phone, according to a signal from the switch sw.

Additionally, an output end of the motor 30 is provided with a speed reducer 35, and the speed reducer 35 is a combination of normal epicyclic gears to decrease the rotation force of the motor 30 at a predetermined rate and increase a torque while preventing a reversing movement. In the driving means constructed as above, the rotation force generated by the motor 30 is decreased by the speed reducer 35 to rotate the output end with torque increased.

The dynamic transfer means comprises the hinge shaft 40′ and the hinge cam 45′, and as shown in the drawing, the hinge cam 45′ is connected to the output end (not shown) of the speed reducer 35, and is rotated integrally with the speed reducer. The hinge shaft 40′ has a taper formed inside in order to make its central part concaved. Additionally, the hinge shaft 40′ is positioned in the fixing unit 15 corresponding to one side of the housing on which the hinge cam 45′ is installed, and has a taper on its both sides with its central part projected for being engaged with the hinge cam 45′.

The hinge shaft 40′ and the hinge cam 45′ having the foregoing construction is influenced by the elastic force of the elastic body 50 having a form of a coil spring, to form a fixing part by being engaged with each other in case that the driving force of the driving means is transferred. The shaft and the cam are detached in case that external force is applied to the folder 20 during an automotive mode operation or during a manual opening/closing of the folder 20.

More specifically, the elastic body 50 applies a larger force to the hinge cam 45′ and the hinge shaft 40′ than the driving means in case the folder 20 is opened or closed with respect to the body 10 by the driving means, so that the engagement state of the hinge shaft 40′ and the hinge cam 45′ is maintained. In case of opening/closing the folder 20 manually, elastic transformation is generated so that the hinge cam 45′ and the hinge shaft 40′ are possibly detached each other.

Here, the hinge cam 45′ and the hinge shaft 40′ are substantial elements having characteristics of the present invention. The characteristics thereof will be described in the following.

Also, a part of the hinge shaft 40′ connected with the hinge cam 45′ is approximately a triangular prism shape of a pentahedron, and its edge part forms a curved surface.

Additionally, one surface of the hinge cam 45′ connected with the hinge shaft 40′ has, on its edge, a projection that has more gently curved edges, compared with the construction of the related art.

Namely, the hinge cam 45′ has a concaved central part and a mountain shape of edges at both sides so that force applied to the operation surface of the hinge shaft 40′ can be dispersed in a radial direction and an axial direction of the housing 25 when the hinge cam 45′ rotates, engaged with the hinge shaft 40′.

The operation of the auto folder type mobile phone of the present invention having the foregoing construction, will be described in the following.

First of all, when a user rotates the folder 20 in a forward direction or a reverse direction with respect to the body 10 in order to manually close/open the folder, the housing 25 rotates integrally in the forward/reverse direction according to the rotation of the folder 20.

Here, the rotation force applied to the housing 25 is larger than the elastic force generated by the elastic body 50, so that the hinge shaft 40′ and the hinge cam 45′ are slipped and separated from each other.

Namely, the hinge cam 45′ is rotated integrally with the housing 25, whereby the hinge shaft 40′ goes back, compressing the elastic body 50, and the folder is possibly opened and closed.

Additionally, in case that the switch sw positioned at one side of the body 10, is operated in order to automatically open the folder 20, the motor and the speed reducer 35 generate a driving force by the signal from the switch.

Subsequently, the hinge cam 45′ is connected with the output end of the speed reducer 35 and rotated integrally, and the hinge shaft 40′ connected with the hinge cam 45′ rotates by a predetermined angle, thereby compressing the elastic body 50, so that the hinge shaft 40′ is moved horizontally by a restoration force of the elastic body 50 upon operation of the driving means.

Namely, the hinge cam 45′ within the housing 25 is given the rotation force from the driving means in the state of mutual engagement with the hinge shaft 40′ arranged in facing direction, and the elastic force of the elastic body 50 is larger than the driving force from the driving means, so that the hinge cam 45′ and the hinge shaft 40′ maintain the mutual engagement, and resultantly, the driving means is rotated.

At the moment, the hinge shaft 40′ rotates in an interior of the hinge cam 45 without going over a top when the hinge shaft 40′ crosses the hinge cam 45′, so that a direction of the force is dispersed not in a rotation direction of the hinge cam 45′, but in an axial direction and a radial direction of the housing 25, whereby noise is decreased.

Namely, rotational movement is transferred, but transfer of external force due to elastic force to the axial direction is blocked, so that the load transferred to the axis could be reduced and elastic force due to elastic body 50 is not delivered to the speed reducer 35, which is the driving means. Therefore, backlash phenomenon is prevented and resultantly, improvement in reliability and performance, and reduction in noise are expected.

In the meantime, in case that the load is applied to the folder 20 while the folder 20 is closed, the folder 20 is opened/closed in the same way as the foregoing, and noise is decreased.

As is apparent from the foregoing, the auto folder type mobile phone of the present invention, resolve the existing problem that the product is devaluated due to “clatter” noise, thereby achieving improvement in reliability, noise reduction, and performance improvement as well as remarkably improving product quality.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An auto folder type mobile phone comprising:
a pair of fixing units, each of which is positioned at one end of a body, with holes facing each other;
a cylinder shaped housing, connected with a folder, positioned between the pair of the fixing units, with its both sides opened;
a driving means, mounted in an interior of the housing, for selectively generating a rotation force;
a hinge shaft, one end of which is connected with the driving means, for being rotated integrally with the driving means, and the other end of which has a projected connection part; and
a hinge cam provided to an interior of the fixing units, one end of which receives supporting force of an elastic body, for being connected with the connection part, wherein the one end has a concaved central part and a mountain shape of curved edges in both sides, so that force applied to the operation surface of the hinge shaft, is dispersed in an axial direction and a radial direction.

2. The mobile phone according to claim 1, wherein the connection part of the hinge shaft is a triangular prism shape of a pentahedron, and its edge forms a curved surface.

3. The mobile phone according to claim 1, wherein the connection part of the hinge shaft and a portion connected with the hinge cam are formed for being engaged with each other by corresponding size.

4. The mobile phone according to claim 1, wherein the driving means comprises a motor connected to a switch, for generating rotational force in forward and reverse directions, and a speed reducer connected to an output end of the motor, for preventing reversing movement, reducing rotation rate.

5. The mobile phone according to claim 1, wherein the driving means receives an operation signal from a switch provided to one side of the body, for generating rotational force in forward and reverse directions.

6. The mobile phone according to claim 1, wherein the elastic body is provided to an interior of the fixing unit, one end of which is fixed in one side of the interior of the fixing units, the other end of which applies elastic force toward the hinge shaft, and the elastic body is a coil spring elastically transformed so that the hinge cam is possibly rotated by external force applied to the folder.

7. The mobile phone according to claim 4, wherein the motor is fixed in an interior of the housing, for operating integrally.

8. The mobile phone according to claim 4, wherein the speed reducer is connected with one end of the hinge shaft, for delivering decreased rotational force.

9. An auto folder type mobile phone comprising:
a pair of fixing units, each of which is positioned at one end of a body, with holes facing each other;
a cylinder shaped housing, connected with a folder, positioned between the pair of the fixing units, and its both sides are opened;
a driving means, mounted in an interior of the housing, for selectively generating a rotation force;
a hinge shaft provided to an interior in one side of the fixing unit, for being moved elastically to a side of the housing, influenced by supporting force from the elastic body, and whose end portion extended to a housing side, has a connection part of a projected shape; and
a hinge cam, one end of which is connected with the driving means, for being rotated integrally, and the other end of which is elastically connected with the hinge shaft, wherein the other end has a concaved central part and a mountain shape of curved edges at both sides so that force applied to the operation surface of the hinge shaft can be dispersed in a radial direction and an axial direction.

10. The mobile phone according to claim 9, wherein the connection part of the hinge shaft is a triangular prism shape of a pentahedron, and its edge forms a curved surface.

11. The mobile phone according to claim 9, wherein the connection part of the hinge shaft and a portion connected with the hinge cam are formed for being engaged with each other by corresponding size.

12. The mobile phone according to claim 9, wherein the driving means comprises a motor connected to a switch, for generating rotational force in forward and reverse directions, and a speed reducer connected to an output end of the motor, for preventing reversing movement, reducing rotation rate.

13. The mobile phone according to claim 9, wherein the driving means receives an operation signal from a switch provided to one side of the body, for generating rotational force in forward and reverse directions.

14. The mobile phone according to claim 9, wherein the elastic body is provided to an interior of the fixing units, one end of which is fixed in one side of the interior of the fixing units, the other end of which applies elastic force toward the hinge shaft, and the elastic body is a coil spring transformed elastically so that the hinge cam is possibly rotated by external force applied to the folder.

15. The mobile phone according to claim 12, wherein the motor is fixed in an interior of the housing, for operating integrally.

16. The mobile phone according to claim 12, wherein the speed reducer is connected with one end of the hinge shaft, for delivering decreased rotational force.
